(19) United States
(12) Patent Application Publication
(10) Pub. No.: US 2014/0210984 A1
(43) Pub. Date: Jul. 31, 2014

(54) System, Apparatus, And Method For Gas Turbine Leak Detection

(71) Applicant: GENERAL ELECTRIC COMPANY, Schenectady, NY (US)

(72) Inventors: Douglas Corbin Warwick, Roswell, GA (US); Alston Ilford Scipio, Mableton, GA (US); Eduardo Mendoza, Marietta, GA (US); Peter Matthijs Jolles, Marietta, GA (US); Sanji Ekanayake, Mableton, GA (US)

(73) Assignee: General Electric Company, Schenectady, NY (US)

(21) Appl. No.: 13/751,346

(22) Filed: Jan. 28, 2013

(51) Int. Cl. H04N 7/18

(52) U.S. Cl. CPC H04N 7/18
USPC 348/81

(57) ABSTRACT

Disclosed are systems, apparatuses, and methods for monitoring fluid passage. In an embodiment, a device may receive a thermographic image of a region comprising a fluid passage. Subsequently the device may determine that the thermographic image comprises an image pattern indicative of a degraded portion of the fluid passage.

### TECHNICAL FIELD

The technical field generally relates to power generation systems and more specifically relates to monitoring of fluid passages.

### BACKGROUND

Gas turbines are utilized globally for power generation and process applications. These gas turbines primarily move large amounts of high pressure air throughout the gas turbine and overboard through discharge piping into the exhaust plenum for start bleed and into the hot gas path for air cooling. Numerous valves are required to shutoff and control the flow through theses pipes. The valves and pipes commonly leak air overboard that cause performance inefficiencies such as higher fuel consumption. Flags on a stick or heat guns are currently used to detect air leaks.

Methods as described above generally are not able to predict and prevent significant turbine air leaks and subsequent damage. Furthermore, due to inherent time delays associated with analyzing faults, determining failure causes, and identifying corrective action steps, use of present methods often results in undesirable lengths of repair time for critical turbine components.

### BRIEF DESCRIPTION OF THE INVENTION

Disclosed herein are methods, apparatuses, and systems for monitoring fluid passages. In an embodiment, a system may comprise a thermographic camera, a controller that includes a processor and memory. The thermographic camera may be directed toward a region including at least one fluid passage, wherein the thermographic camera is configured to output a signal indicative of a thermographic image of the region. The controller may be communicatively coupled to the thermographic camera. The memory of the controller may be communicatively coupled with the processor, wherein the memory may have stored thereon executable instructions that when executed by the processor cause the processor to effectuate operations comprising: analyzing the thermographic image; and determining that at least a portion of the thermographic image is indicative of a degraded portion of a fluid passage.

In an embodiment, a device may comprise a processor and a memory. The memory of the device may be communicatively coupled with the processor, wherein the memory may have stored thereon executable instructions that when executed by the processor cause the processor to effectuate operations including receiving a thermographic image of a region comprising a fluid passage and determining that the thermographic image comprises an image pattern indicative of a degraded portion of the fluid passage.

In an embodiment, a method may comprise receiving a thermographic image of a region comprising a fluid passage; determining that the thermographic image comprises an image pattern indicative of a degraded portion of the fluid passage; and responsive to determining that the thermographic image comprises an image pattern indicative of a degraded portion of the fluid passage, generating an alert message.

This Brief Description of the Invention is provided to introduce a selection of concepts in a simplified form that are further described below in the Detailed Description. This Brief Description of the Invention is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an exemplary illustration of a gas turbine;

FIG. 2 is an exemplary illustration of a gas turbine system that includes cooling and sealing air valve and pipe components;

FIG. 3 is an exemplary illustration of a thermographic image of a section of fluid passage at time T1;

FIG. 4 is an exemplary illustration of a thermographic image of a section of fluid passage at time T2;

FIG. 5 illustrates a non-limiting, exemplary method of implementing a thermographic image detection system;

FIG. 6 is an exemplary block diagram of a thermographic image detection system; and

FIG. 7 is an exemplary block diagram representing a general purpose computer system in which aspects of the methods and systems disclosed herein or portions thereof may be incorporated

### DETAILED DESCRIPTION OF THE INVENTION

Embodiments of the present disclosure may provide systems, devices, and methods for detecting a leak within a fluid passage or anticipating a degraded portion of the fluid passage that may lead to a leak (e.g., a significantly weakened fluid passage). For example, certain embodiments may include a thermographic camera directed toward a region including at least one fluid passage. The thermographic camera may be configured to output a signal indicative of a thermographic image of the region to a controller communicatively coupled with the thermographic camera. The controller may be configured to detect a leak or anticipate a leak within the at least one fluid passage based on the signal. For example, the controller may analyze a thermographic image of the region which may include image pattern recognition analysis to determine whether the thermographic image includes an area indicative of a fluid leak or anticipated fluid leak. The controller may also compare a rate of temperature change in a particular area to a threshold value indicative of a fluid leak or anticipated fluid leak. A crack or significantly degraded area in a fluid passage may have an abnormal image pattern as well as an abnormal temperature. For example, a fluid passage may have an abnormally high temperature or abnormal thermographic image pattern near a crack in comparison with surrounding portions of the fluid passage or other components.

A controller may be coupled to a user interface configured to display a thermographic image of fluid passages or other gas turbine equipment. Numerical temperatures, an indicator of a leak location, or an indicator of a degraded section of a fluid passage may be overlaid on the thermographic image. In an embodiment, an indicator of the location of the alarm condition (e.g., leak/crack/degradation) may be placed on a common camera image that may have a similar perspective view as the thermographic image of a region. In certain embodiments, the controller may be configured to activate an audible and/or visual alarm after detection of an actual or anticipated leak in order to alert an operator to the condition. In further embodiments, the controller may be configured to automatically terminate fluid flow through the at least one fluid passage upon detection of an actual leak or anticipated leak. Flow through the fluid passage may be terminated prior to significant damage to the fluid passage that would cause significant fluid leakage, significant loss in efficiency, or damage to other gas turbine components.

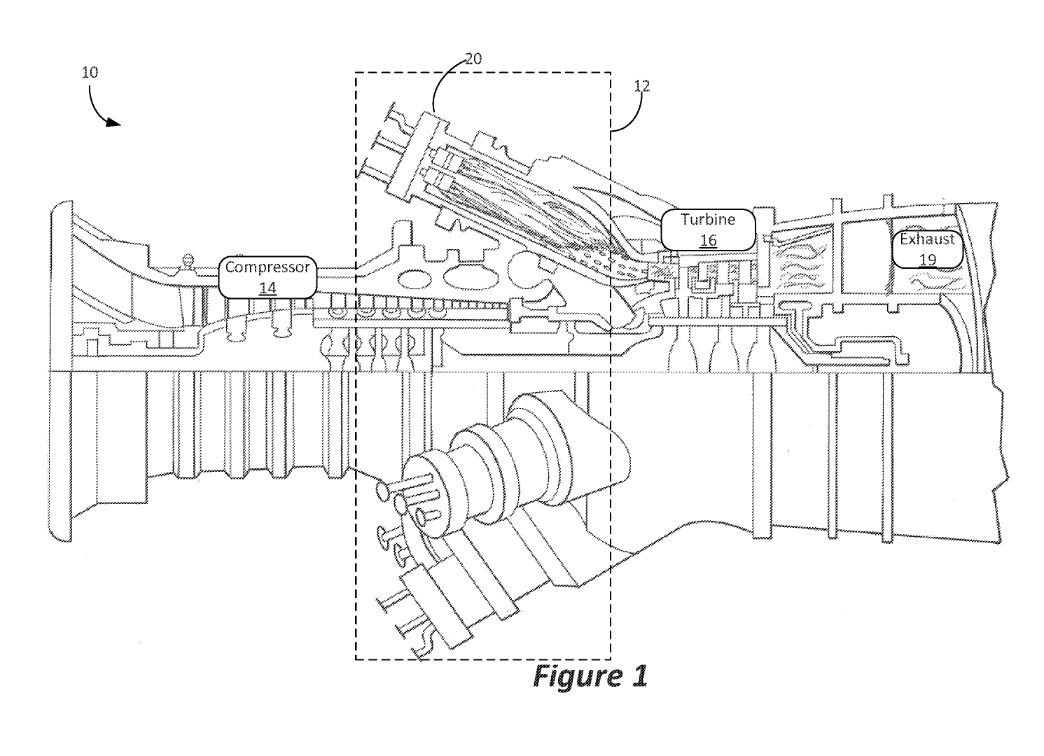

FIG. 1 is an exemplary illustration of a partial cross section of a gas turbine 10. As shown in FIG. 1, gas turbine 10 has a combustion section 12 in a gas flow path between a compressor 14 and a turbine 16. The combustion section 12 may include an annular array of combustion components around the annulus. The combustion components may include combustion chamber 20, and attached fuel nozzles. The turbine 16 is coupled to rotationally drive the compressor 14 and a power output drive shaft (not shown). Air enters the gas turbine 10 and passes through the compressor 14. High pressure air from the compressor 14 enters the combustion section 12 where it is mixed with fuel and burned. High energy combustion gases exit the combustion section 12 to power the turbine 16 which, in turn, drives the compressor 14 and the output power shaft. The combustion gases exit the turbine 16 through the exhaust duct 19 and may enter into a heat recovery steam generator (HRSG) to extract additional energy from the exhaust gas.

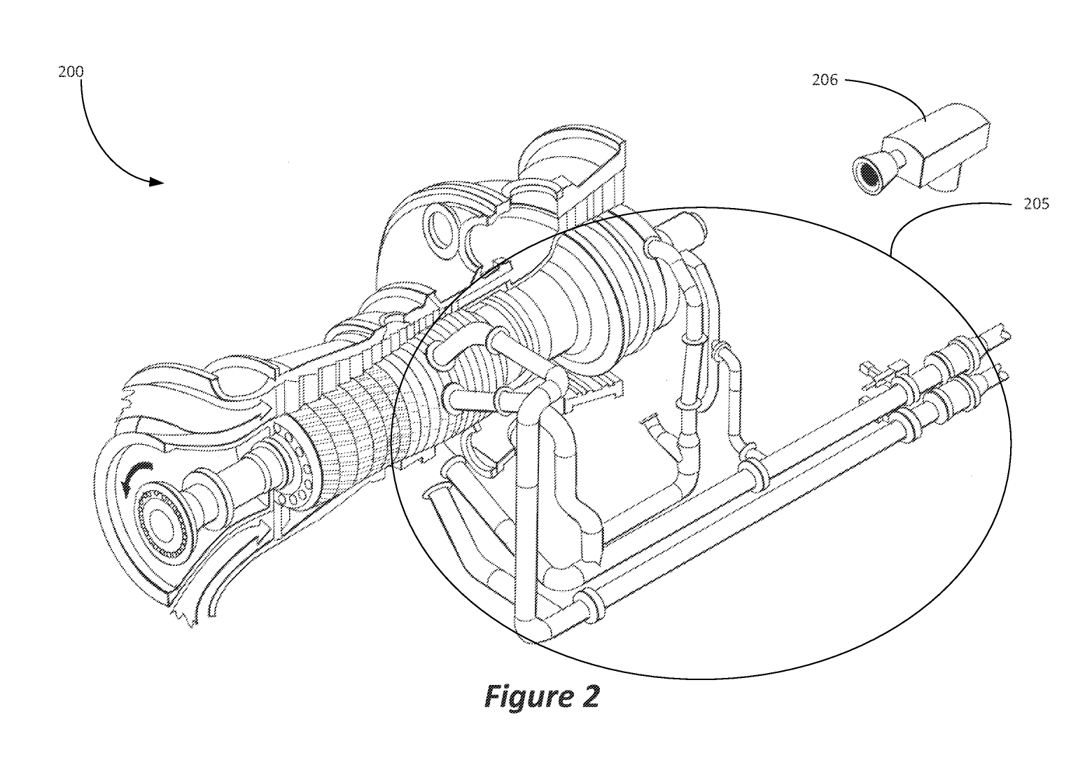

FIG. 2 is an exemplary illustration of a gas turbine system 200 that includes cooling and sealing air valve and pipe components. A thermographic camera 206 may be directed to area 205. Thermographic camera 206 may capture the radiation of piping and other components in area 205 in a thermographic image. The thermographic image may be a color coded image, wherein a range of colors indicate different degrees of radiation emitting from area 205. The color pattern may be shown on a display and may generally be mapped to different temperatures. The color change may be so small that only a machine may be able to discern the different temperatures mapped to different colors. In an embodiment, an operator may use a user interface to select a point or area on a thermographic image and receive a temperature reading for that point or area.

A thermographic camera 206 (also known as an infrared camera) is a device that forms an image using infrared radiation, similar to the way that a common camera that forms an image using visible light. A thermographic camera may convert the thermal radiance emitted by an object/body into a still image. Thermographic cameras may also produce standard video signal (e.g., PAL at 25 frames per second). Generally speaking, the higher an object's temperature, the more infrared radiation is emitted as black-body radiation. A thermographic may work even in total darkness because ambient light levels are of minimal affect in the capturing the thermographic image. When used for temperature measurement, the brightest (warmest) parts of the image are customarily colored white, intermediate temperatures reds and yellows, and the dimmest (coolest) parts blue. A scale may be used to relate colors to temperatures. Since the figures herein are black and white, for illustration purposes patterns that are normally shown in color in figures herein are displayed using patterns that may be representative of color.

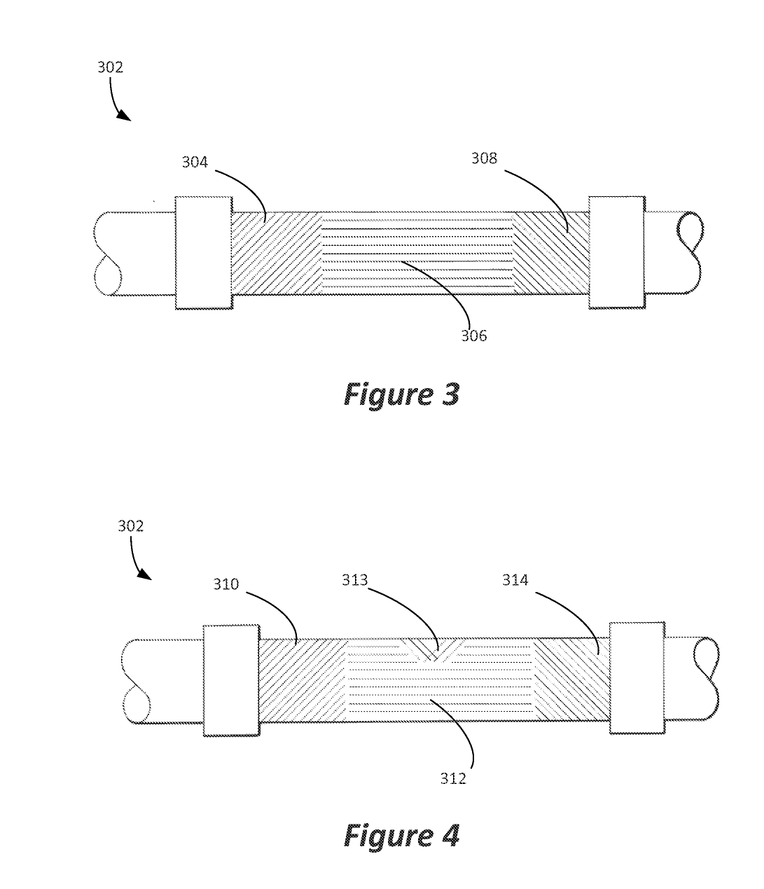

FIG. 3 displays a section of fluid passage 302 at time T1 with pattern 304, pattern 306, and pattern 308. FIG. 4 displays fluid passage 302 at time T2, with pattern 310, pattern 312, pattern 313, and pattern 314. The cross hatch patterns 304, 308 in FIGS. 3 and 310 and 314 in FIG. 4 are representative of a thermal radiation patterns or color gradients of a thermographic image. Fluid passage 302 at T1 may pass fluid “normally” (e.g., within expected parameters) through the fluid passage 302 with no fluid leakage in FIG. 3. Fluid passage 302 at T2 in FIG. 4 may be abnormally passing fluid. In an embodiment, fluid passage 302 at T1 with pattern 308, 306, and 304 may be compared to fluid passage 302 at T2 with pattern 310, pattern 312, pattern 313, and pattern 314. Pattern 313 may be indicative of a crack in the fluid passage 302 at 314. Similar image pattern detection may be used in order to anticipate a degradation of an area of a fluid passage that may eventually lead to a crack.

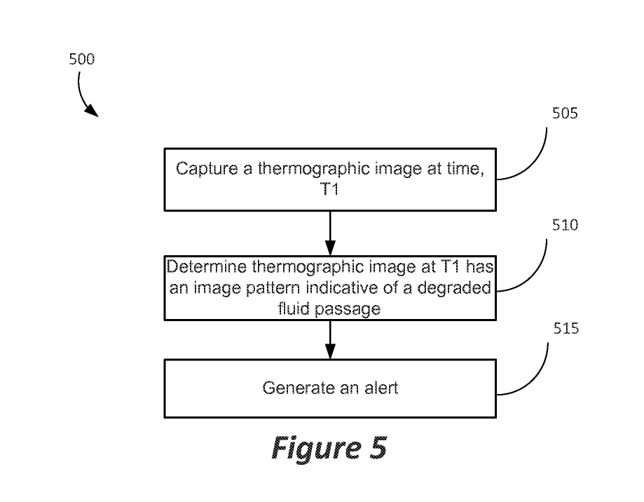

FIG. 5 illustrates a non-limiting, exemplary method 500 of implementing a thermographic image detection system. At 505, a thermographic camera may capture a thermographic image at time, T1. The thermographic camera may be a video camera or a still camera. At 510, the thermographic image of T1 may be determined to be an image pattern indicative of a degraded fluid passage (e.g., an opening that leaks fluid). The determination may be done by analysis of the thermographic image T1 compared to a baseline thermographic image of the captured area of thermographic image T1. The baseline thermographic image may be for different operational modes or running conditions of a power generation system. For example, there may be different baselines for a fluid passage when a gas turbine is operating with three combustors compared to the same gas turbine running with 5 combustors. In another example, the baseline thermographic image for a fluid passage may be different when different compressed air to fuel mixtures are used in the combustion process. In an embodiment, there may be an analysis of fluid passage radiation over several hours of operation (e.g., months or years) in order to establish an expected fluid passage performance generally or for a particular fluid passage (i.e., predict future degradation or life of a fluid passage based on past performance).

At 515, an alert may be generated. The alert may be sent to an operator via a user interface. In an embodiment, the alert may be sent to another portion of the plant control system to automatically alter the operation of the power generation system. For example, it may be determined that the degraded fluid passage (which may be a leak or an anticipated leak), may have a longer life if the gas turbine operated in a different manner (e.g., using 4 instead of 5 combustors). A change in the operation of the power generation system, may avert an inconvenient total power generation system shutdown, and allow the operator to setup a convenient time to perform repairs on the degraded fluid passage.

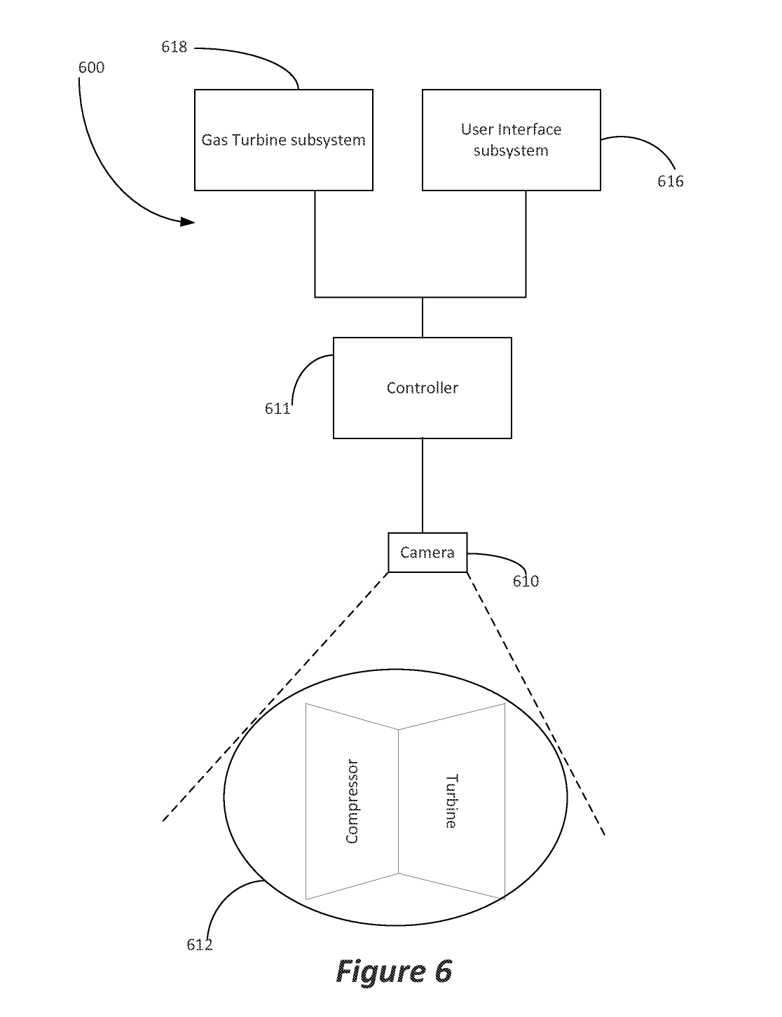

FIG. 6 is an exemplary block diagram of a thermographic image detection system 600. The thermographic image detection system 600 may be configured to detect fluid leaks within a power generation system. The thermographic image detection system 600 includes thermographic camera 610 that may be directed toward a region 612 of a power generation system. The thermographic camera 610 may be configured to output a signal indicative of a thermographic image of the region 612 comprising compressor/turbine components that include fluid passages. In an embodiment, a plurality of thermographic cameras may be directed toward region 612 to capture different perspectives. As discussed herein, the intensity of certain infrared emissions (e.g., radiation) may be proportional to the temperature of the object. In certain embodiments, the thermographic camera 610 may be configured to detect such emissions and output a signal indicative of temperature.

In system 600, thermographic camera 610 may be communicatively coupled to a controller 611. Controller 611 may be configured to analyze a thermographic image from region 612 and detect a degraded fluid passage which may be leaking. Controller 611 may also be able to determine the degree of degradation of a fluid passage in region 612, e.g., currently leaking, anticipated to leak in the near future, or at an acceptable level. Controller 611 may be configured to recognize image patterns indicative of a degraded fluid passage, wherein a thermographic image at time T1 may be compared to a baseline thermographic image. Controller 611 may be communicatively connected with other subsystems within the power generation system 600, such as a gas turbine control 618 and user interface subsystem 616, among other subsystems. Controller 611 may receive operation data from gas turbine subsystem 618 in order to determine whether a fluid passage image for region 612 is within acceptable temperature or image pattern thresholds for running at a particular operation level (e.g., using 4 instead of 5 combustors).

For example, if a crack develops within a fluid passage conveying heated exhaust gas from gas turbine 10 to and HRSG (not shown), the radiation pattern of the area surrounding the fluid passage may increase due to the leaking gas. Thermographic camera 610 may transmit a signal indicative of a thermographic image. The thermographic image may comprise a pattern of colors and corresponding temperatures. The controller 611 may receive the signal and identify the fluid leak based on the image pattern which may be indicative of an increase or another abnormal change in temperature. Before an alert is generated, the abnormal change in temperature may be based on a consistent change in temperature (or image pattern) over a threshold period of time. Controller 611 may manipulate the thermographic image and place an indicator in the image on the probable source of the fluid leak. In an embodiment, controller 611 may place an indicator on a common camera image similar to the perspective of the thermographic image of region 612. A “common camera” takes pictures in light of the visible spectrum. As discussed herein, leaks may be quickly detected, and appropriate corrective action may be taken with minimal downtime or loss of fuel as compared to other leak detection systems. In certain embodiments, the controller 611 may be communicatively coupled to a power generation system and configured to automatically shut down fluid or otherwise alter flow to a leaking or significantly degraded fluid passage.

User interface 616 may be communicatively coupled to controller 611. User interface 616 may include a graphical display configured to display a thermographic image with an overlaid coordinate plane. In an embodiment, controller 611 may monitor temperature and thermographic image patterns for each coordinate within the coordinate plane. An operator may be able to select one or more coordinates and display the temperature of the one or more coordinates as a function of time. Controller 611 may be configured to more closely monitor the image patter or temperature of a coordinate on a thermographic image and alert an operator when temperature or image pattern differences reach a threshold level. In this manner, an operator may monitor the temperature to determine whether a fluid leak is present, determine whether contaminates may be in the fluid, or determine whether there are other fluid passage abnormalities.

The thermographic image detection system 600 disclosed herein may be used to pinpoint the source of a leak on a thermographic image. It should be appreciated that the present embodiments may be employed to detect leaks within fluid passages such as valves, seals, connectors, joints, or other passages configured to convey a fluid. The present thermographic image detection system 600 may be utilized to detect fluid leaks from components of other systems, such as processing plants, oil refineries or combustion engines, for example.

Without in any way limiting the scope, interpretation, or application of the claims appearing herein, a technical effect of one or more of the example embodiments disclosed herein is to provide a thermographic image detection system that allows for continuous monitoring of fluid passages for leak detection and proactive monitoring for significant fluid passage degradation. An operator may be alerted of leaks or degradation and fluid passages may be automatically closed in response to detected leaks or fluid passage degradation.

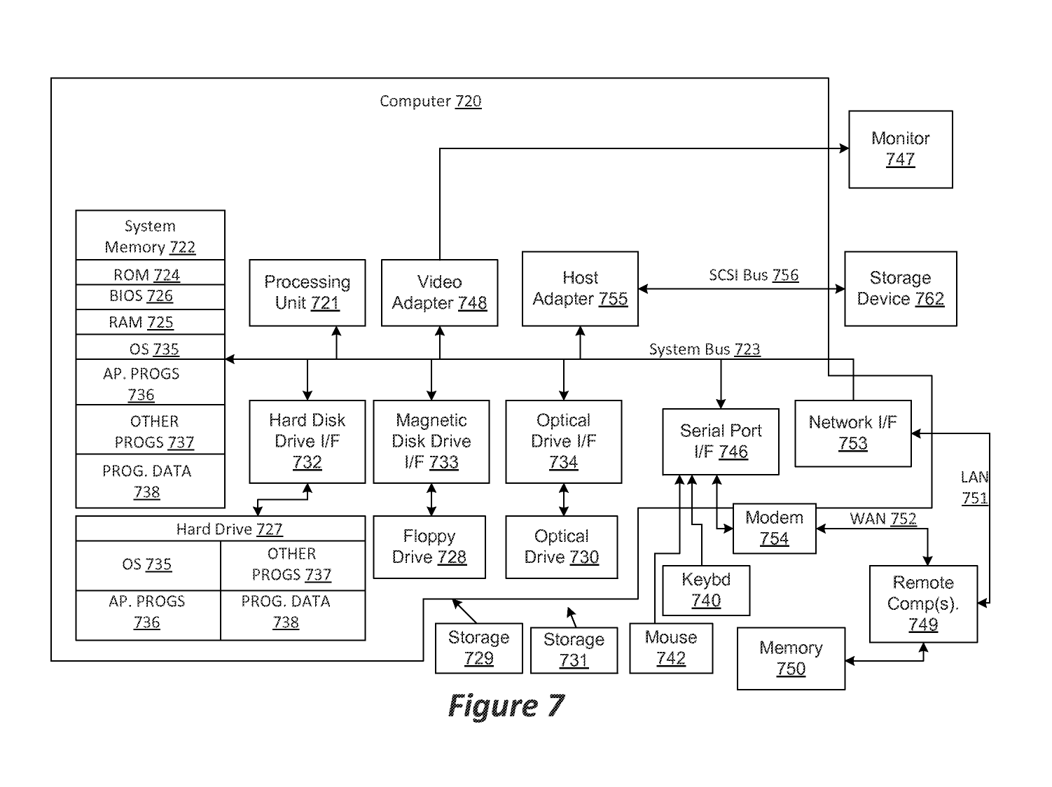

FIG. 7 and the following discussion are intended to provide a brief general description of a suitable computing environment in which thermographic image detection systems, methods, and devices disclosed herein and/or portions thereof may be implemented. Although not required, the thermographic image detection systems, methods, and devices disclosed herein may be described in the general context of computer-executable instructions, such as program modules, being executed by a computer, such as a client workstation, server or personal computer. For example, controller 611, gas turbine subsystem 618, user interface subsystem 616, and camera 610 may all have computer components that execute instructions. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 7 is a block diagram representing a general purpose computer system in which aspects of the methods and systems disclosed herein and/or portions thereof may be incorporated. As shown, the exemplary general purpose computing system includes a computer 720 or the like, including a processing unit 721, a system memory 722, and a system bus 723 that couples various system components including the system memory to the processing unit 721. The system bus 723 may be any of several types of bus structures including a memory bus or memory controller, a peripheral bus, and a local bus using any of a variety of bus architectures. The system memory includes read-only memory (ROM) 724 and random access memory (RAM) 725. A basic input/output system 726 (BIOS), containing the basic routines that help to transfer information between elements within the computer 720, such as during start-up, is stored in ROM 724.

The computer 720 may further include a hard disk drive 727 for reading from and writing to a hard disk (not shown), a magnetic disk drive 728 for reading from or writing to a removable magnetic disk 729, and an optical disk drive 730 for reading from or writing to a removable optical disk 731 such as a CD-ROM or other optical media. The hard disk drive 727, magnetic disk drive 728, and optical disk drive 730 are connected to the system bus 723 by a hard disk drive interface 732, a magnetic disk drive interface 733, and an optical drive interface 734, respectively. The drives and their associated computer-readable media provide non-volatile storage of computer readable instructions, data structures, program modules and other data for the computer 720. As described herein, computer-readable media is an article of manufacture and thus not a transient signal.

Although the exemplary environment described herein employs a hard disk, a removable magnetic disk 729, and a removable optical disk 731, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 729, optical disk 731, ROM 724 or RAM 725, including an operating system 735, one or more application programs 736, other program modules 737 and program data 738. A user may enter commands and information into the computer 720 through input devices such as a keyboard 740 and pointing device 742. Other input devices (not shown) may include a microphone, joystick, game pad, satellite disk, scanner, or the like. These and other input devices are often connected to the processing unit 721 through a serial port interface 746 that is coupled to the system bus, but may be connected by other interfaces, such as a parallel port, game port, or universal serial bus (USB). A monitor 747 or other type of display device is also connected to the system bus 723 via an interface, such as a video adapter 748. In addition to the monitor 747, a computer may include other peripheral output devices (not shown), such as speakers and printers. The exemplary system of FIG. 7 also includes a host adapter 755, a Small Computer System Interface (SCSI) bus 756, and an external storage device 762 connected to the SCSI bus 756.

The computer 720 may operate in a networked environment using logical connections to one or more remote computers, such as a remote computer 749. The remote computer 749 may be a personal computer, a server, a router, a network PC, a peer device or other common network node, and may include many or all of the elements described above relative to the computer 720, although only a memory storage device 750 has been illustrated in FIG. 7. The logical connections depicted in FIG. 7 include a local area network (LAN) 751 and a wide area network (WAN) 752. Such networking environments are commonplace in offices, enterprise-wide computer networks, intranets, and the Internet.

When used in a LAN networking environment, the computer 720 is connected to the LAN 751 through a network interface or adapter 753. When used in a WAN networking environment, the computer 720 may include a modem 754 or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing a communications link between the computers may be used.

Computer 720 may include a variety of computer readable storage media. Computer readable storage media can be any available media that can be accessed by computer 720 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 720. Combinations of any of the above should also be included within the scope of computer readable media that may be used to store source code for implementing the methods and systems described herein. Any combination of the features or elements disclosed herein may be used in one or more embodiments.

The systems described herein are for the purpose of providing context for embodiments of a thermographic image detection system for detecting leaks and anticipated leaks within fluid passages or degradation of performance of a gas turbine system by monitoring fluid passages. It should be appreciated that the thermographic image system described herein may be utilized within other power generation systems, turbine systems, processing plants, or any other system including fluid passages. It should be appreciated that further embodiments of the thermographic image system may include more or fewer thermographic cameras directed toward a plurality of regions of a power generation system.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed:

1. A system comprising:
a thermographic camera directed toward a region including a fluid passage, wherein the thermographic camera is configured to output a signal indicative of a thermographic image of the region; and
a controller communicatively coupled to the thermographic camera, wherein the controller comprises:
a processor; and
a memory coupled to the processor, the memory having stored thereon executable instructions that when executed by the processor cause the processor to effectuate operations comprising:
analyzing the thermographic image; and
determining that at least a portion of the thermographic image is indicative of a degraded portion of the fluid passage.

2. The system of claim 1, wherein the memory has executable instructions that when executed by the processor cause the processor to effectuate operations further comprising:
responsive to the determining that at least a portion of a thermographic image is indicative of a degraded portion of the fluid passage, generating an alert message including instructions to alter fluid flow through the fluid passage.

3. The system of claim 1, wherein the determining that at least the portion of the thermographic image is indicative of a degraded portion of the fluid passage is based on image pattern recognition.

4. The system of claim 1, wherein the degraded portion of the fluid passage comprises at least one of a leaking portion of the fluid passage or a cracked portion of the fluid passage.

5. The system of claim 1, wherein the memory has executable instructions that when executed by the processor cause the processor to effectuate operations further comprising:
responsive to the determining that at least a portion of a thermographic image is indicative of a degraded portion of the fluid passage, generating an alert message comprising a common camera image of a location of the degraded portion of the fluid passage.

6. The system of claim 1, wherein the determining that at least a portion of the thermographic image is indicative of a degraded portion of the fluid passage is based on:
if a temperature of a first area of the thermographic image exceeds a first threshold value; or
if a temperature of the first area of the thermographic image decreases below a second threshold value.

7. The system of claim 1, wherein the determining that at least a portion of the thermographic image is indicative of a degraded portion of the fluid passage is based on if a rate of change of temperature of a first area of the thermographic image exceeds a threshold value.

8. The system of claim 1, wherein the region comprises a power generation system including the fluid passage.

9. A device comprising:
a processor; and
a memory coupled to the processor, the memory having stored thereon executable instructions that when executed by the processor cause the processor to effectuate operations comprising:
receiving a thermographic image of a region comprising a fluid passage; and
determining that the thermographic image comprises an image pattern indicative of a degraded portion of the fluid passage.

10. The device of claim 9, wherein the memory has executable instructions that when executed by the processor cause the processor to effectuate operations further comprising:
responsive to the determining that the thermographic image comprises an image pattern indicative of a degraded portion of the fluid passage, generating an alert message.

11. The device of claim 9, wherein the memory has executable instructions that when executed by the processor cause the processor to effectuate operations further comprising:
responsive to the determining that the thermographic image comprises an image pattern indicative of a degraded portion of the fluid passage, generating an alert message that comprises information for an anticipated time frame before the degraded portion of the fluid passage will leak.

12. The device of claim 9, wherein the degraded portion of the fluid passage comprises at least one of a leaking or a cracked fluid passage.

13. The device of claim 9, wherein determining that the thermographic image is indicative of a degraded portion of the fluid passage is based on:
if a temperature of a first area of the thermographic image exceeds a first threshold value; or
if a temperature of a first area of the thermographic image decreases below a second threshold value.

14. The device of claim 9, wherein determining that the thermographic image is indicative of a degraded portion of the fluid passage is based on whether a rate of change of temperature of a first area of the thermographic image exceeds a threshold value.

15. The device of claim 9, wherein the region comprises a power generation system.

16. A method comprising:
receiving a thermographic image of a region comprising a fluid passage;
determining that the thermographic image comprises an image pattern indicative of a degraded portion of the fluid passage; and
responsive to the determining that the thermographic image comprises an image pattern indicative of a degraded portion of the fluid passage, generating an alert message.

17. The method of claim 16, wherein the alert message comprises information for an anticipated time frame before the degraded portion of the fluid passage will leak.

18. The method of claim 16, wherein the degraded portion of the fluid passage comprises at least one of a leaking or a cracked fluid passage.

19. The method of claim 16, wherein the determining that the thermographic image is indicative of a degraded portion of the fluid passage is based on:
if a temperature of a first area of the thermographic image exceeds a first threshold value; or
if a temperature of a first area of the thermographic image decreases below a second threshold value.

20. The method of claim 16, wherein the alert message comprises instructions to alter fluid flow through the fluid passage.
